(19) United States
(12) Patent Application Publication
(10) Pub. No.: US 2010/0288956 A1
(43) Pub. Date: Nov. 18, 2010

(54) VALVE ACTUATOR

(75) Inventor: Filippo Dordoni, Cortemaggiore (IT)

Correspondence Address: YOUNG & THOMPSON, 209 Madison Street, Suite 500, Alexandria, VA, 22314, US

(73) Assignee: DVG AUTOMATION S.P.A., Cortemaggiore (Piacenza) (IT)

(21) Appl. No.: 12/863,791

(22) PCT Filed: Jan. 5, 2009
(86) PCT No.: PCT/IB2009/050004

§ 371 Date: Jul. 21, 2010

(30) Foreign Application Priority Data
Jan. 28, 2008 (IT) PR2008A000006

(51) Int. Cl. F16K 31/44

(52) U.S. Cl. 251/213

(57) ABSTRACT

A valve actuator device (1) of the type adapted to convert a reciprocating rectilinear motion into a reciprocating angular motion and vice versa in valve actuators, of the type including a sleeve (2) adapted to be keyed to a corresponding rotation driving shaft, a slider (4) sliding along linear guides (5), one or more forks (3) integral with the sleeve for holding an element (6) extending from the slider (4) in the gap (3b) between its prongs, to generate a translational motion upon rotation of the sleeve and vice versa. Three or more equally spaced rods (5) are provided for guiding the slider, and are arranged to define the vertices of a regular polygon with the center of application of the stem (11) or the center of gravity of the slider, to prevent any torque or rotation moment from building up on the slider as it slides on the rods.

The present invention relates to a valve actuator, i.e. a device for converting a reciprocating rectilinear motion into a reciprocating angular motion and vice versa.

Devices are known to be used in the art of valve actuators for converting the rectilinear motion of an actuator into a rotary motion of a valve stem, or vice versa, by a mechanism known as sliding block linkage.

Namely, a sliding block linkage allows conversion of the uniform rotary motion of a flywheel driven by a motor into a reciprocating rectilinear motion.

The object of the present invention is to provide a device for valve actuators that can ensure conversion of reciprocating linear motion into reciprocating rotary motion and vice versa, with features to:
reduce friction of moving parts,
optimize the distribution of sliding components by using a number of rectilinear guiding rods, in such an arrangement as to neutralize any torque on the device

These objects and advantages are achieved by a device for converting a reciprocating rectilinear motion into a reciprocating angular motion and vice versa, according to the present invention, which is characterized by the annexed claims.

This and other features will be more apparent from the following description of a few embodiments, which are shown by way of example and without limitation in the accompanying drawings, in which:

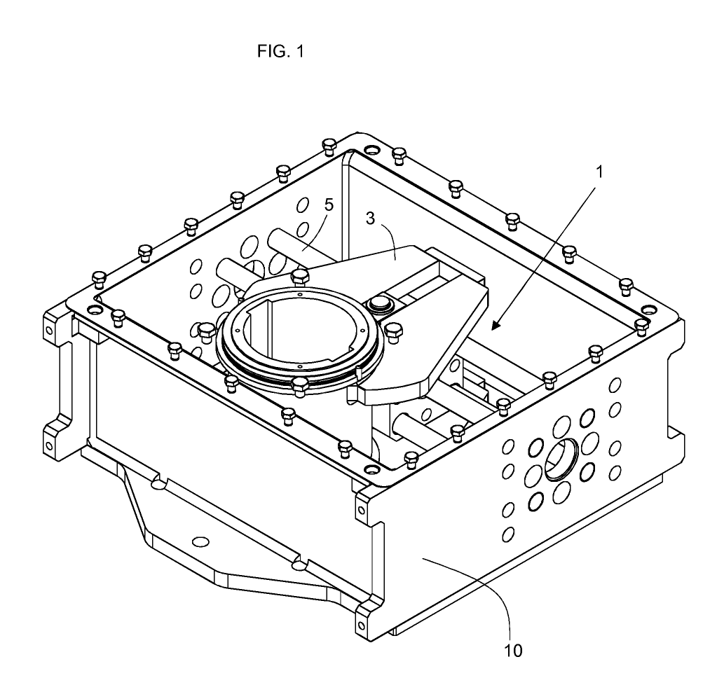

FIG. 1 is a perspective view of a drive device for valve actuators of the present invention

FIG. 2 shows the motion conversion device proper of the device as shown in FIG. 1,

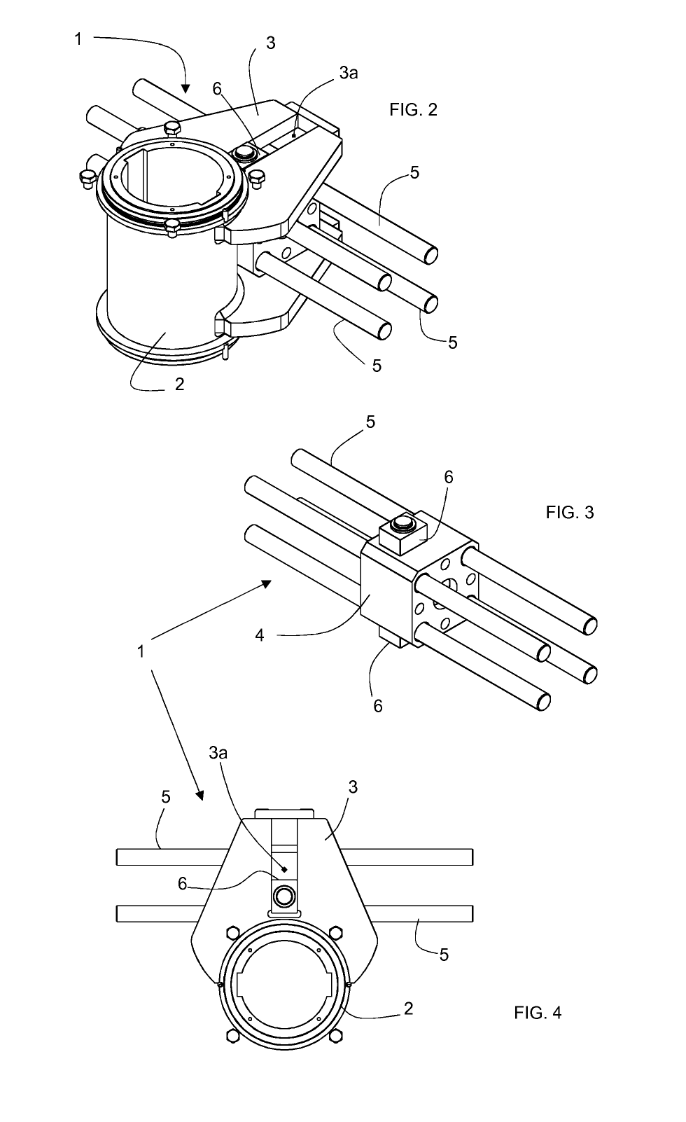

FIG. 3 shows the slider and the guiding rods of the linear translation mechanism of the device of FIG. 1,

FIG. 4 is a top view of the device of FIG. 2.

Referring to FIGS. 1, 2, 3 and 4, numeral 1 generally designates a valve actuator, i.e. a device for converting a reciprocating rectilinear motion into a reciprocating angular rotary motion.

Namely, the device 1 comprises a case 10 for housing the rectilinear/rotary motion converting components.

Here, a sleeve 2 may be seen, here having a hollow cylindrical section, which is adapted to be keyed to a corresponding shaft (not shown) such as a valve driving shaft or the like, to cause rotation about its axis A1.

A pair of forks 3 extend perpendicular to the axis A1 of said sleeve 2, and are adapted to hold a an element 6 in the gap or groove 3b created between the fork prongs, which element projects vertically, along the axis A3, from a slider 4 and is attached thereto, for instance, by suitable threads.

The above part 6 may be of any shape whatever, as long as it may be keyed into the corresponding groove 3b.

The above slider 4 is capable of linear sliding motion, due to the action of a stem 11 which is in turn controlled, for example, by a hydraulic or pneumatic cylinder and is free to slide on equally spaced guiding rods 5, relative to the center of application of the stem 11 of the slider 4

The guiding rods 5 are integral with two inner, opposite walls of the case 10 and their purpose is to prevent torques or rotation moments from building up on the slider 4 as the latter slides along the rods 5.

The center of application of the stem 11 on the slider will preferably correspond to the center of gravity of the latter.

Therefore, the slider 4 will be displaced by a linear motion, perpendicular to the above axes A1 and A3, as shown by the reference A2, to cause linear motion upon rotation of the sleeve 2: the guiding rods 5 are obviously perpendicular to the axis of the sleeve 2, for rectilinear/rotary motion conversion.

While the embodiment as shown herein has four guiding rods 5, there may be also three or more of such guides, without departure from the scope of the invention, which are all equally spaced from the center of application of the stem 11, i.e. arranged at the vertices of a regular polygon whose center of gravity is the center of application of the stem 11.

1. A valve actuator (1) of the type adapted to convert a reciprocating rectilinear motion into a reciprocating angular motion and vice versa in valve actuators, of the type comprising a sleeve (2) adapted to be keyed to a corresponding rotation driving shaft, a slider (4) sliding along linear guides (5), one or more forks (3) integral with the sleeve (2) for holding an element (6) extending from said slider (4) in the gap (3b) between its prongs, to generate a translational motion upon rotation of the sleeve (2) and vice versa, characterized in that it comprises three or more equally spaced rods (5) for guiding the slider (4), and arranged to define the vertices of a regular polygon with the center of application of the stem (11) or the center of gravity of the slider (4), to prevent any torque or rotation moment (4) from building up on the slider (4) as it slides on the rods (5).

2. An actuator (1) as claimed in claim 1, characterized in that the slider (4) will be displaced by a linear motion, perpendicular to the axis (A1) of the sleeve (2), to cause linear motion upon rotation of the sleeve (2).
